(19) United States
(12) Patent Application Publication
(10) Pub. No.: US 2002/0120535 A1
(43) Pub. Date: Aug. 29, 2002

(54) Website system and method for providing on-line data-exchange and a collaborative service of return and repair process

(76) Inventor: Spencer Yu, Taipei City (TW)

Correspondence Address: BACON & THOMAS, PLLC, 4th Floor, 625 Slaters Lane, Alexandria, VA, 22314-1176, US

(21) Appl. No.: 09/793,632

(22) Filed: Feb. 27, 2001

(51) Int. Cl. G06F 17/60

(52) U.S. Cl. 705/29; 705/7

(57) ABSTRACT

The present invention discloses a website system for providing on-line data-exchange and a collaborative service for return and repair processes via a network. The website system has: a website server connected to the network, which has: a database for storing attribute data provided by each member of the service community and generated by the website system; an access controlling means for generating a user ID code for each member of the service community according to the attribute information; a data exchanging means for providing three different interfaces for three parties, respectively, to receive and exchange different data real-time from three parties, the interface having a plurality of unified data formats; a return material authorization (RMA) processor for generating an RMA for a proper repair center and a service requester and managing a life cycle of the RMA, when receiving a service request with the associated data of a returned product from the service requester; a repair execution system (RES) connected to the RMA processor, for administering and tracking a repair activity (process) of the returned product, according to repair data provided by the repair center; a bill evaluating system for evaluating a bill of the repair activity (process) of the returned product for involved parties intelligently, according to the repair data and a predetermined bill splitting rule; and a part procuring system for processing parts procurement for the repair activity (process) by gaining repair data from the RES and the repair center, and sending part data to the product supplier and the bill evaluating system.

### BACKGROUND OF THE INVENTION

1. Field of the Invention

The present invention relates to return and repair processes and, more particularly, to a website system and a method for providing on-line data-exchange and a collaborative service of return and repair process.

2. Description of Related Art

In the past years, enormous amount of interests and resources have been devoted to the streamlining of the manufacturing processes. The fruits of these efforts bring the world new disciplines such as Enterprise Resource Planning (ERP), Supply Chain Management (SCM), and many other acronyms that each stand for a solution to a particular problem encountered by the enterprise. While corporations are pursuing better solutions to push products to the customers more efficiently, the area of return and repair is still not operating at the same level of efficiency as manufacturing. The Original Equipment Manufacturing (OEM) and Contract Equipment Manufacturing (CEM) practices make the return and repair process even more complicated than before.

In the manufactured goods business, commonly the first step of a return process is the request for Return Material Authorization (RMA) for most businesses. RMA, in one way, can be viewed as a reverse of the ordering cycle. When customers want to return the goods they've purchased they have to contact the supplier of goods to get an agreement that the supplier will take the goods back. The formal name of this agreement is called RMA.

Nonetheless, the RMA is just the first step of a complicate return and repair process. Two possible scenarios are described below:

1. Return and Repair Process in Single Organization

If the manufacturer makes every component used in its products by itself, the repair and return process is in fact quite simple and straightforward. Since every component is internally built, the warranty information for each component should be easily accessible by all personnel involved in the return and repair process. In addition, the requirement for replacement components should be all fulfilled by internal production. As a result, the cost for repair (labor, parts, etc) should be totally absorbed by either the customer or the manufacturer itself since there is no third party involved.

2. Return and Repair Process in Different Organizations

However, in today's manufacturing world very few, if any, companies build everything themselves. The product manufacturing more or less uses components built by other companies. If the broken component is made by other companies then the repair process becomes somewhat complicated than the single organization scenario. Several steps in the return and repair process now need more information and have to undergo different processes.

a. If the broken component in the returned product is from third party, the manufacturer needs to find out if the broken component is still under warranty from the component manufacturer.

b. For the most of time, the product manufacturer doesn't have the technology and/or capacity to repair the broken component. Therefore, the only repair operation applicable at the product manufacturer's side is to replace the broken component with new component.

c. The manufacturer now has to store certain quantity of third party components for replacement purpose. On the other hand, the component manufacturer has to taken into the replacement production into account when conduct the production plan.

d. The broken third party component now needs to be sent back to the component manufacturer or some repair facility for diagnosis and repair.

e. The cost distributing mechanism now involves component manufacturers. If the broken component is under warranty, then component manufacturer has to pay the cost associated with the replacement component. If the broken component is not under warranty then the manufacturer has to pay for the replacement component first then charges the cost to the customer later.

The return and repair process is now more complicated yet closer to the real world. For component manufacturer the planning for replacement production is now more difficult since the return of component is indirect. On the other hand, the manufacturer has more external dependency on third party on the turnaround time of the repair operation.

### Return and Repair Process for OEM and CEM

Some industries, like personal computer (PC) manufacturing, are running under the OEM model. Therefore, the return and repair process becomes trickier for these products since the OEM doesn't manufacture the product. Instead, it is the CEM that manufactures the product. In a nutshell, it means more parties are involved in the return and repair process.

For example, a customer of a notebook computer finds out his or her notebook has some problem with the LCD display. The customer then sends the notebook computer back to the notebook computer manufacturer's authorized service center (ASC) or dealer for repair or replacement. In the ASC, the only operation it can perform is to replace the whole display module since ASC doesn't have any information regarding the warranty of the LCD display module.

Moving further down to the return and repair process, assume that the notebook computer manufacturer doesn't make the LCD panel itself, it has to send the broken LCD panel back to the original manufacturer. Since most of the LCD panel manufacturers are located in Asia, so do their manufacturing and repair factories, while the notebook computer's ASC and dealer are possibly all around the world. Chance that LCD panel manufacturers will have repair centers all over the world with the expensive LCD panel repairing machinery and in the vicinity of the ASC is rather small. Thus, the LCD panel manufacturers are likely to authorize some other companies to take care of the repairing based on the region. Under this situation the broken LCD panel will be sent to one of the regional repair center.

In the repair center, the usual repair and analysis steps happen as the manufacturer in the single organization scenario does. The complicacies happen when it comes down to the repairing cost distribution. For illustration purpose, assume the following simplified rules apply:

1. If the broken LCD panel is under warranty, LCD panel manufacturer absorbs the repair cost.

2. If the broken LCD panel is out of warranty, OEM absorbs the repair cost. OEM then charges the customer for the repair cost.

3. If the broken LCD panel is scraped, the repair center absorbs the repair cost.

As it turns out, the billing and invoicing process now becomes more complicated in comparison to previous scenarios. Taken into accounts like many manufacturers use LCD panels in notebook computers, flat panel LCD monitors, and cellular phones and computer manufacturer uses many other off-the-shelf components such as CPU, hard disk, CD-ROM, etc. to manufacture its notebook computers, one can quickly comprehend that the management of return and repair process in the OEM/CEM world has become a major challenge for all enterprises involved.

From the above scenarios, especially the one that describes the return and repair process involving OEM and CEM, some problem that impacts the process efficiency can be identified:

1. Lack of Warranty Information: As a common practice, manufacturers usually assign serial number to their products. Some manufacturer may have coding mechanism to include the warranty information inside the serial number. If the decoding algorithm is provided, the warranty information can be inferred from the serial number using the decoding algorithm. However, this static coding mechanism can only record the original manufacturing information. Dynamic warranty information, such as extended warranty, cannot be captured using the serial number coding mechanism.

Furthermore, even if complete warranty information is stored at manufacturer's information system, this information is not easily sharable by the service center, the OEMs and the authorized repair center since this information is usually not open to outside parities. Nonetheless, warranty information is so critical to all parties because it is the basis to determine how the cost of repair should be distributed.

2. Uncertainty of Billing Responsibility: Since the warranty information is not easily accessible, the billing responsibility cannot be clearly distinguished among all parities because billing is based on warranty. In some cases the repair center just assumes all broken components are under warranty and charge the repair cost to the manufacturer. The manufacturer then has to spend enormous amount of resources to validate each billing request from repair center, reject the invalid billing request because the product is out of warranty. If a billing request is rejected, the repair center then has to find other party to absorb the repair cost or otherwise absorb the cost itself.

3. Lack of Inventory Visibility: Another problem emerged is related to the inventory visibility, especially on the forecast of demand and supply. This problem manifests itself when the manufacturing and repairing are not conducted in the same company. The demand information from repairing operation cannot be reflected in the demand forecast at the manufacturer's side causing the manufacturer relies on inaccurate information to predict the inventory level for parts used in repair operation. On the other hand, the parts supply information from the manufacturer side cannot be easily consolidated into repairer's material requirement planning. As a consequence, the inventory visibility for both manufacturer and repairer diminishes.

4. Waste of Resources and Materials: As the consequence of the problems mentioned above, considerable amount of resource and materials has been wasted in this inefficient return and repair process. The waste of resource happens during the resolution of billing dispute, frequent modification of demand and supply forecast, the possible idle hours due to the shortage of materials required for repair or the extra time and money spent on expediting the material required for repair.

Meanwhile, materials can be wasted in several different ways. The manufacturer may produce too many parts for repair that doesn't happen. The repairer may store too many parts under the “just-in-case” mentality due to the unreliability of supply. Or material can be wasted in the repairing process just because changing part is the only way repairer can bill the original manufacturer.

5. Lack of Quality Information: Quality information is collected when the defect items go through the diagnosis and repair process. However, with the outsourcing of repair operation the quality information does not feed back to the manufacturer in real time. The manufacturer will not realize any potential quality problem for the products until the repair information has been collected from the repairer and has gone through certain analysis. In today's network economy, this means lower customer satisfaction and can lead to losing customer's business due to inferior service.

Apparently, none of the alternatives mentioned above can provide a satisfactory, efficient solution to streamline the intricacy of today's return and repair process. Companies have tried many different ways to resolve this intricacy. Also, the ERP vendors start being aware of this problem and have released new modules target to cope with return and repair problem. Nonetheless, the ERP system is not design to handle complicate return and repair process. On the other hand, the capability of the new ERP module is so limited that it simply cannot be considered as a viable solution. Therefore, it is desirable to provide an improved speech recognition method to mitigate and/or obviate the aforementioned problems.

### SUMMARY OF THE INVENTION

The object of the present invention is to provide a high level overview on how the state-of-the-art technologies can help manufacturers and contracted repairing companies to streamline the return and repair process.

The object of the present invention is to provide a website system for providing on-line data-exchange and a collaborative service for return and repair processes via a network. The website system of the present invention has the following characteristics:

Developing and providing all the applications and services.

Hosting all the applications and services in a centralized location, i.e., a website.

The application and service of the present invention reflect the exact return and repair process.

Each partner (Customers, OEM, CEM, ASC, Repair Center, and Manufacturer) signs in to the website as member.

To achieve the object, the website system of the present invention includes: a website server connected to the network, a database, an access controlling means, a data exchanging means, a power limiting means, a return material authorization (RMA) processor, a repair execution system (RES), a bill evaluating system and a part procuring system.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of the web site system according to the present invention.

FIG. 2 is a main flowchart of the present invention.

FIG. 3 shows a service route drawing of the three parties of the present invention.

FIG. 4 shows a flowchart of user access controlling of the present invention.

FIG. 5 shows a flowchart of service charge billing of the present invention.

FIG. 6 shows a flowchart of inventory managing of the present invention.

FIG. 7 to FIG. 16 are relative displaying screens of a RMA process of the website for three parties of the present invention.

### DETAILED DESCRIPTION OF THE PREFERRED EMBODIMENT

In the following detailed description numerous specific detailed are set forth in order to provide a thorough understanding of the present invention. However, it will be understood by those skilled in the art that the present invention may be practiced without these specific details. In other instances well known methods, procedures, components, and circuits have not been described in detailed so as not to obscure the present invention.

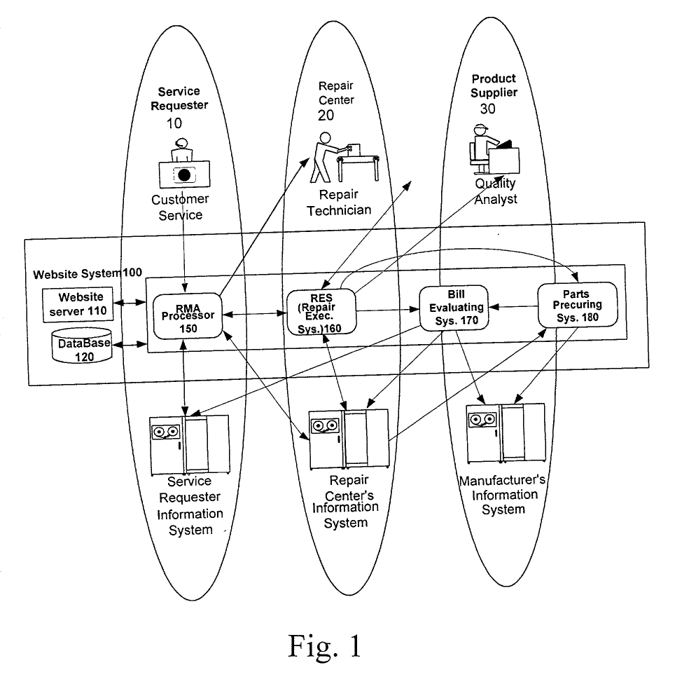

Please refer to FIG. 1. FIG. 1 is a schematic diagram of the website system 100 according to the present invention. The website system 100 provides on-line data-exchange and a collaborative service for return and repair processes via a network 40. The website system 100 enables integration of service information from a service community. The service community includes: a service requester party 10, a repair center party 20, and a product supplier party 30. The website system 100 includes: a website server 110 connected to the network 40, a database 120, an access controlling means 130, a data exchanging means 140, a return material authorization (RMA) processor 150, a repair execution system (RES) 160, a bill evaluating system 170 and a part procuring system 180.

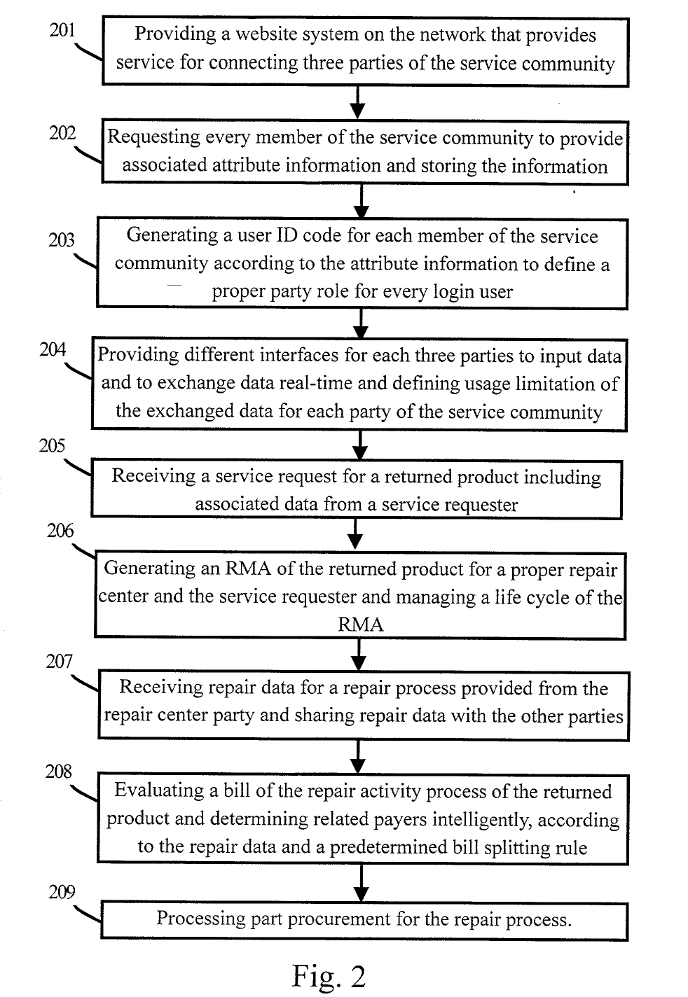

Please refer to FIG.2. FIG. 2 is a main flowchart of the present invention. The following description explains more detail about the processing steps of the present invention.

Step 201: the present invention provides the website system 100 on the network 40 for connecting three parties of the service community togetrher. The website system 100 provides a return and repair information processing platform for three parties 10, 20, 30 of the service community.

Step 202: The website system 100 requests every joining member to provide associated attribute information and stores the information in the database 120. The attribute information of member profile may include company location, business domain, product type, etc.

Step 203: The access controlling means 130 of the website system 100 generates a user ID code for each member according to the attribute information to define a proper party role for every login user. Furthermore, every member of the service community can be defined as more than one party role and have more than one different user ID codes.

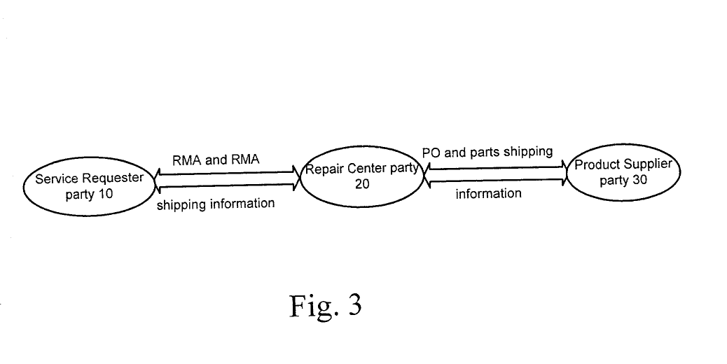

Step 204: the data exchanging means 140 provides three different interfaces for three parties, respectively, to receive and exchange different data real-time from three parties. Additionally, the access controlling means 130 further comprises a power limiting means 132 for defining usage limitation of exchanged data for each party by controlling the content of the interfaces of the data exchanging means 140. Please refer to FIG.3. FIG. 3 shows a flowchart of user access controlling of the present invention. Therefore, when a user logins into the website system 100 and input its ID code, the website system 100 will identify the party role for the user and display a respective interface. The interface has a plurality of unified data formats for the user to input data and to obtain exchanged data. However, the power limiting means 132 enables a website system administrator to determine the interface with different information items for each party, respectively.

Step 205: the website system 100 receives a service request for a returned product, the service request includes associated data of the returned product from a service requester. The service requester can be a customer, an OEM, a CEM, or an ASC. The associated data may include a series number and a failure description inputted by the service requester. After the website system 100 displays the respective interface to a login user of the service requester party 10. The user utilizes the information items of the displaying interface determined by the power limiting means 132 to input data in a unified data format.

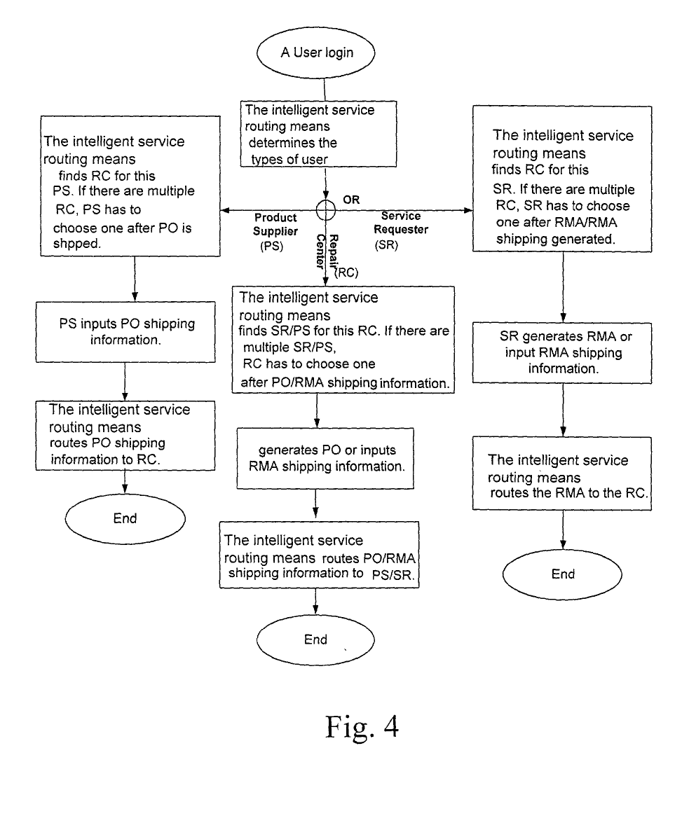

Step 206: the return material authorization (RMA) processor 150 generates an RMA of the returned product for a proper repair center and the service requester and manages a life cycle of the RMA. The life cycle of the RMA includes status, turn-around time (TAT), yield rate, failure rate, and part usage. Please refer to FIG.4. FIG. 4 shows a service route drawing of the three parties of the present invention. The return material authorization (RMA) processor 150 further comprises an intelligent service routing means 152 for determining the proper repair center for each service request according to the location of the repair center provided by the user ID. The intelligent service routing means 152 deals with how to process the RMA, RMA shipping information, parts purchasing order (PO) and part shipping information are routed to the right destination. RMA shipping information is the detailed information of RMA product shipped from or to CEM, such as request date, shipped date, types of transportation and carrier name etc. This information as well as RMA are routed between the service requester and the repair center, which both can view this information. Similarly, parts purchasing order (PO) and parts shipping information are routed between the repair center and product supplier. When the data exchanging means 140 receives the service request with the associated data of at least one returned product from the service requester to generate a RMA No to send to the service requester and the repair center.

Step 207: the repair execution system (RES) 160 is connected to the RMA processor 150, the repair execution system 160 administers and tracks a repair process of the returned product(s), according to repair data provided by the repair center. The repair execution system 160 receives repair data for a repair process of the returned product(s) provided from the repair center party and shares repair data with the other parties. The repair data includes return product(s) data, broken symptom, replaced part and repair result etc. The repair execution system 160 further monitors any quality issue discovered in the repair process and altering quality control personnel.

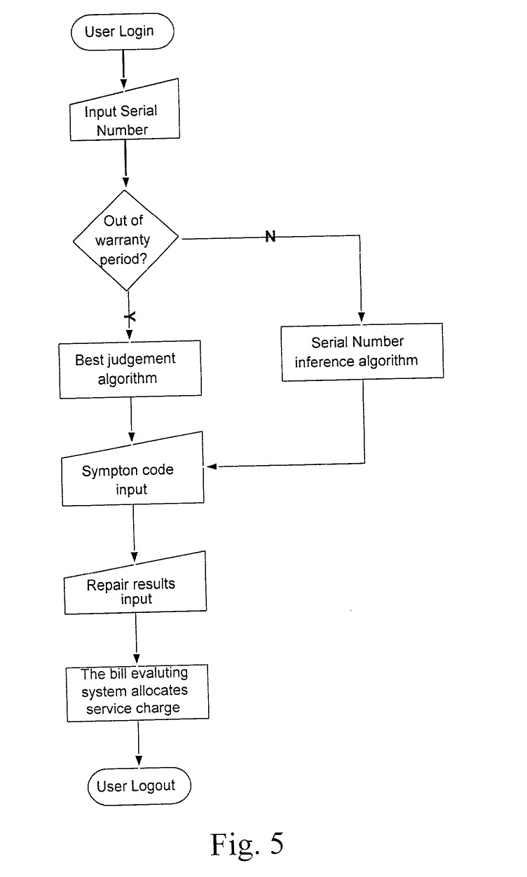

Step 208: the bill evaluating system 170 evaluates a bill of the repair process of the returned product(s) for involved parties intelligently, according to the repair data and a predetermined bill splitting rule. The predetermined splitting rule includes a warranty agreement provided by the product supplier party and repair execution. Please refer to FIG.5. FIG. 5 shows a flowchart of service charge billing of the present invention. The bill includes the repair cost, the parts procurement cost, and the other return and repair related cost. The bill evaluating system 170 solves the problem of how to split service charge to the product supplier, the repair center and the service requester. Basically, the charge is allocated according to warranty, symptom code and repair result.

1) Warranty is managed by one of the following ways.

Serial number inference—The ability to inference warranty information by the serial number of repair item. The suppliers provide the algorithm.

Best judgment algorithm—it can be stored as business policy in the product supplier member profile.

2) Symptom code indicates the cause of failure of repair item. The cause decides the charge responsibility.

Additionally, repair result (pass or scrap) also has effects on the charge splitting.

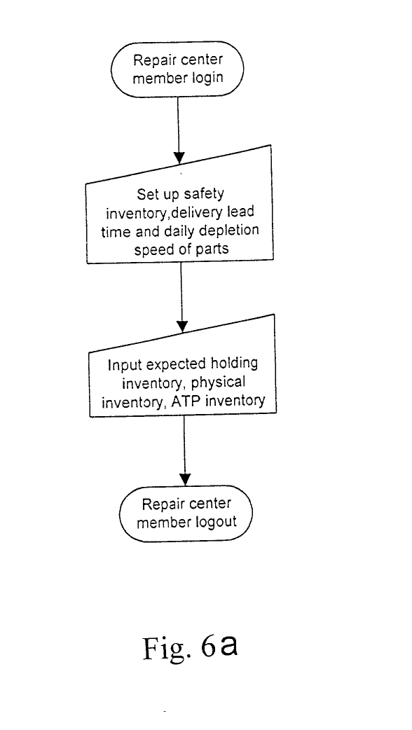

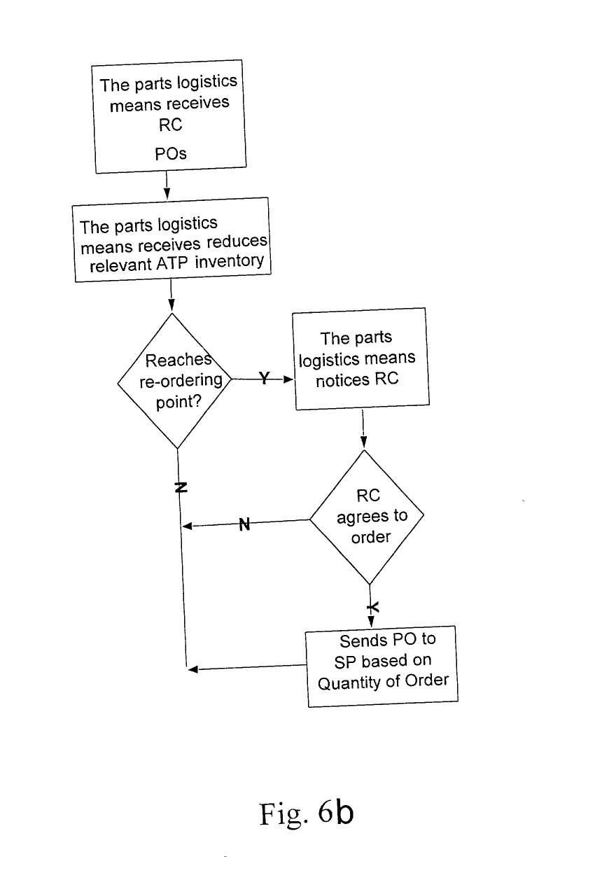

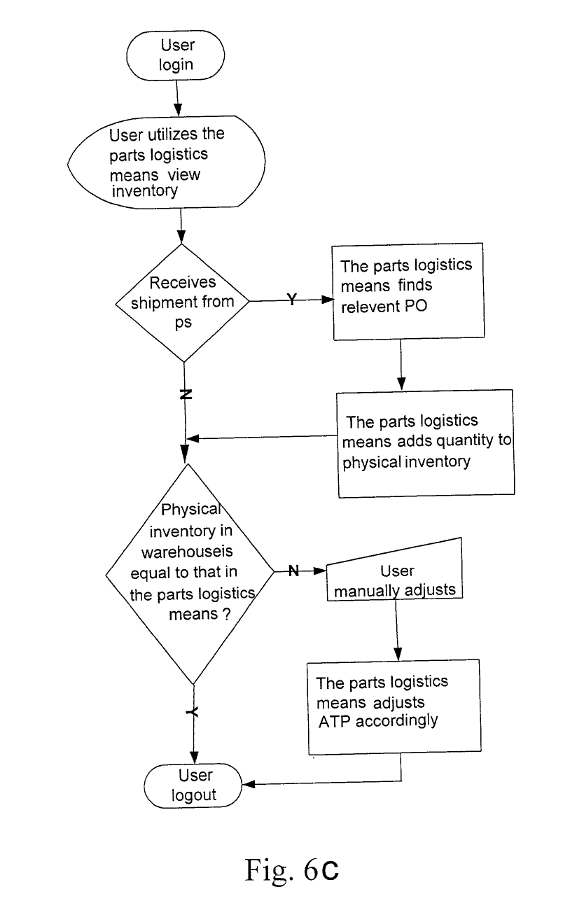

Step 209: the part procuring system 180 processes parts procurement for the repair process by gaining repair data from the RES and the repair center, and sends part data to the product supplier and the bill evaluating system. Please refer to FIG.6. FIG. 6 shows a flowchart of inventory managing of the present invention. The part procuring system 180 further comprises a part logistic means 182. The part logistic means 182 is connected to every inventory database of the repair center party and the product supplier party and the part logistic means 182 orders lacking parts for the repair process from the related product supplier. The part logistic means 182 enables users to set, view, adjust and add inventory. The part logistic means 182 also creates alert information, which could lead to PO if users confirm the alert. Delivery lead-time is the time from the part logistic means 182 sending PO to the time the part logistic means 182 receiving shipment. As shown in FIG. 6a, the part logistic means 182 initiates data provided by different the repair center members.

Wherein

Daily depletion speed of parts=annual consumption of parts/365

or=monthly consumption of parts/days in that month

Expected holding inventory is the amount of inventory that the part logistic means 182 wants to carry.

ATP (available-to-promise) inventory is available-to-promise inventory, ATP=on-hand physical inventory−on-order parts from repair center+on-ship parts from product supplier.

As shown in FIG. 6b, the part logistic means 182 generates an order to product supplier.

Wherein

Re-ordering point=delivery lead time (days)×depletion speed of the parts+safety inventory

ATP inventory=on-hand physical inventory−on-order parts from repair center.

When ATP+on-order parts to supplier<=Re-ordering point, the website system 100 will alert the part logistic means 182. If the part logistic means 182 agrees to place an order, a PO (purchasing order) will be issued to the supplier.

Quantity of Order=Expected Holding inventory−Safety Inventory, expected holding inventory is the inventory the part logistic means 182 is willing to carry.

As shown in FIG. 6b, the part logistic means 182 updates inventory after receipt of shipment.

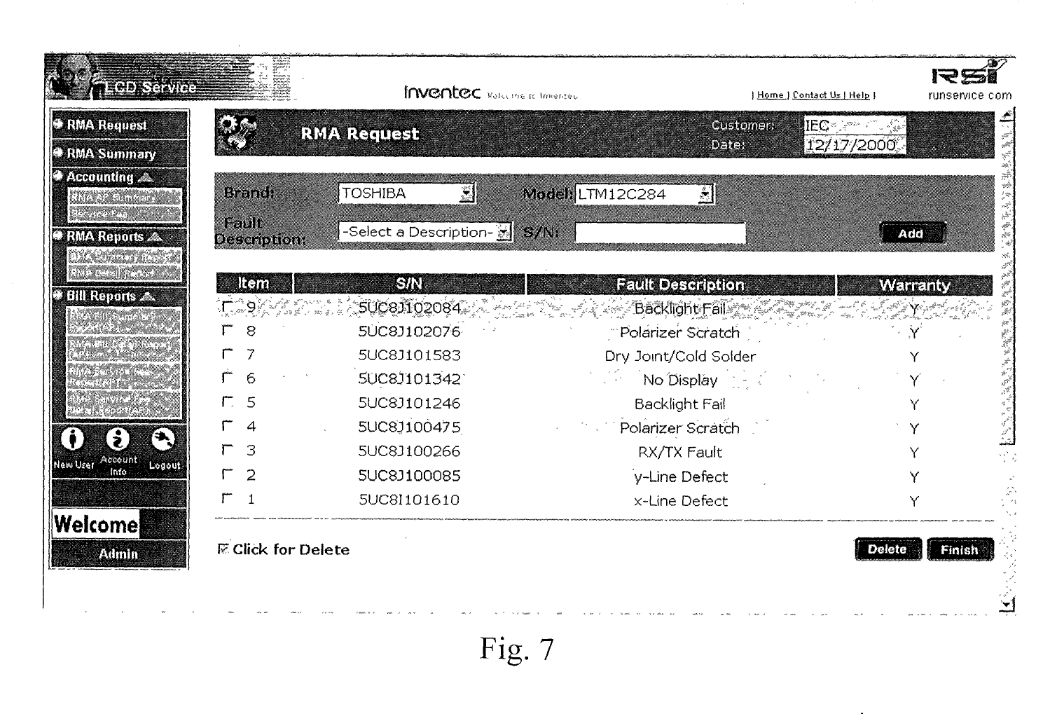

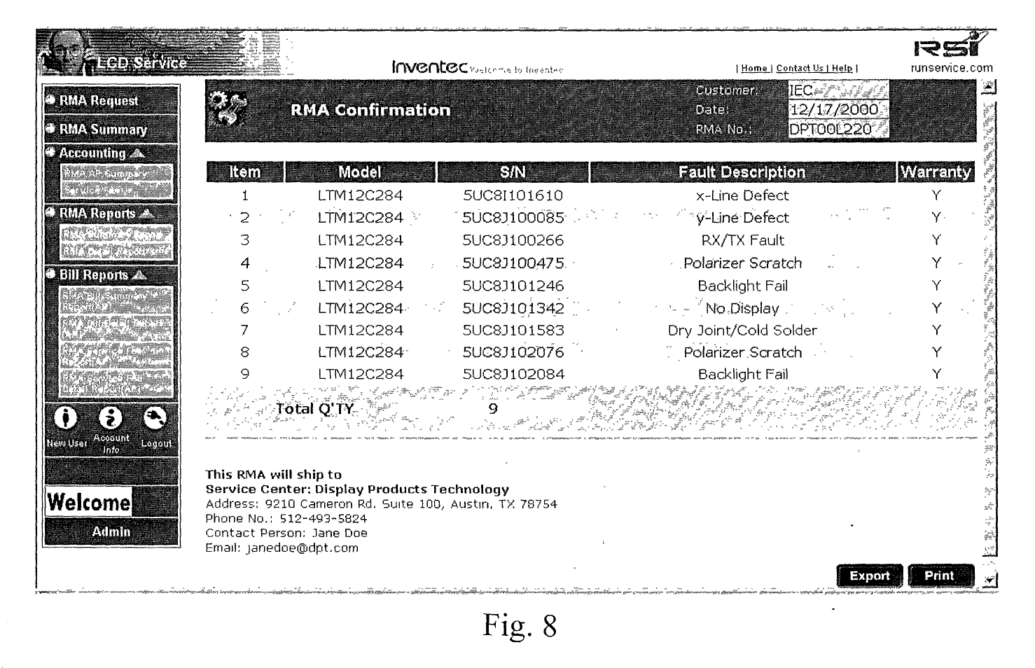

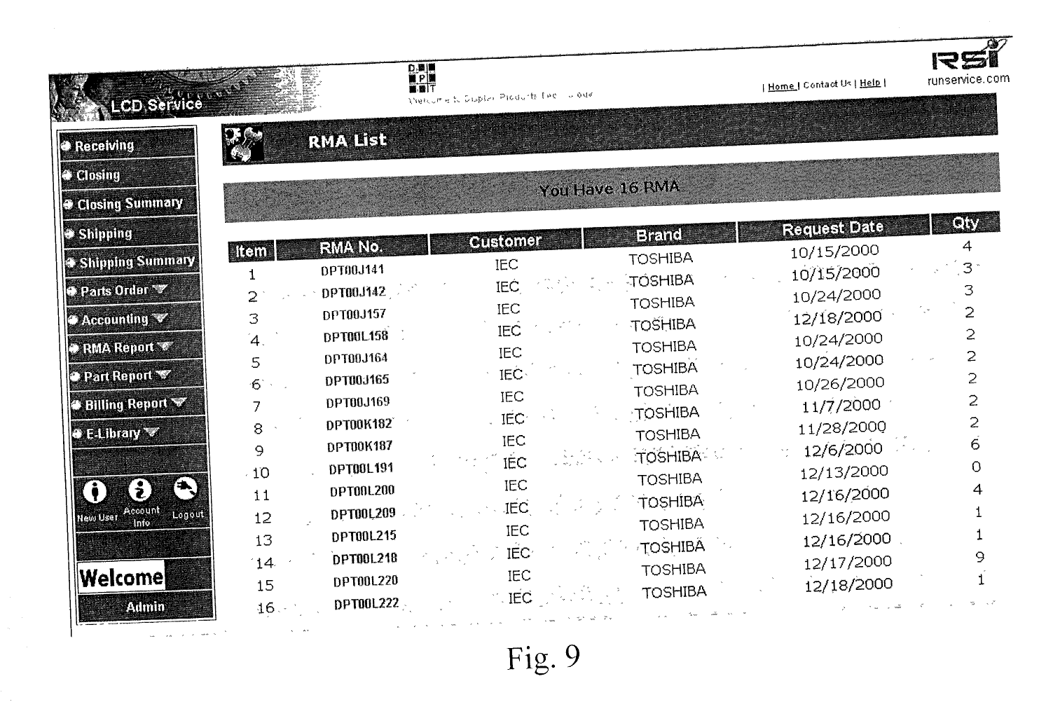

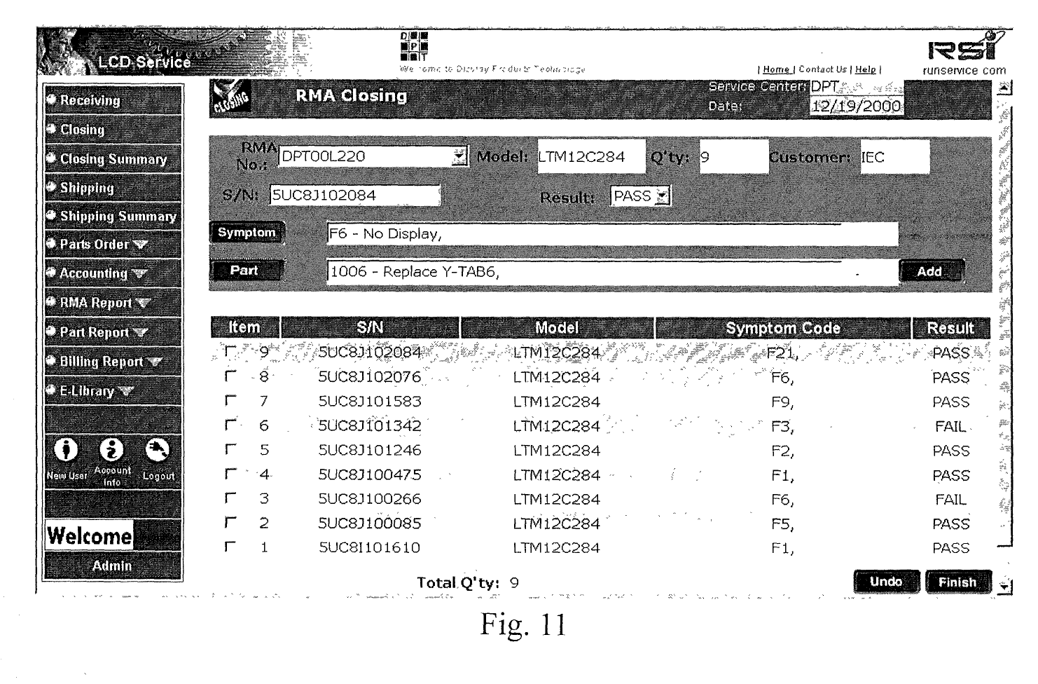

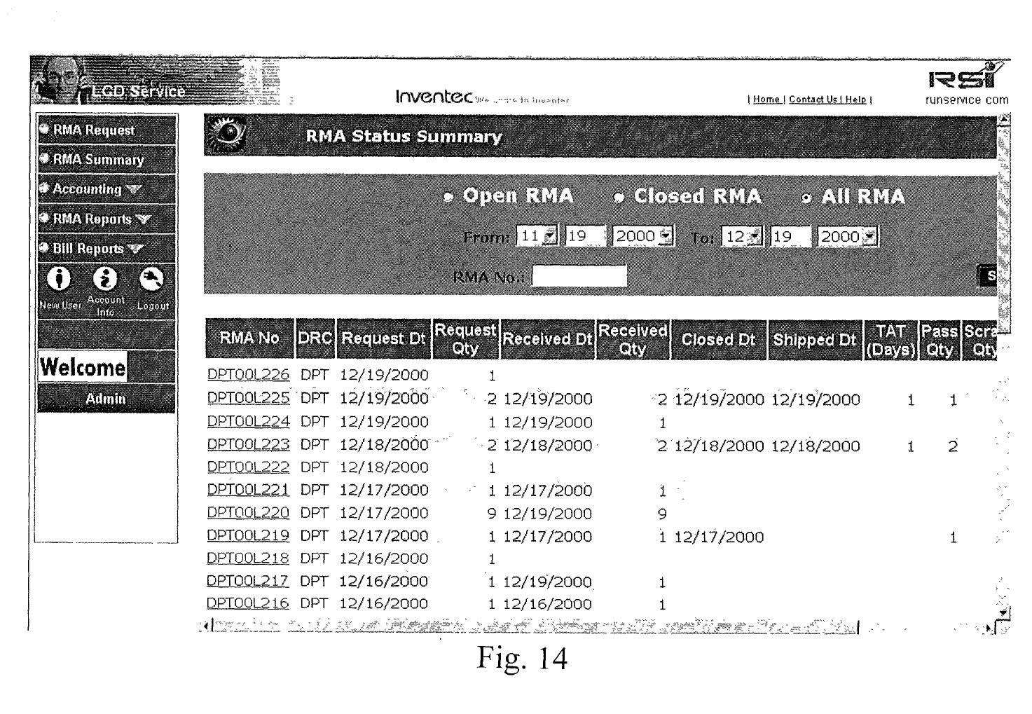

Please refer to FIG. 7 to FIG. 16. FIG. 7 to FIG. 16 are a series of displaying screens of a RMA process for three parties of the present invention. As shown in FIG. 7, a service requester, “Inventec”, logins in the website system 100, the website system 100 displays an interface with a plurality of information items in the left side of the screen for the service requester party. The Inventec is a CEM company for the notebook product. The Inventec clicks the “RMA Request” information item with a unified data format to input request data. In order to sort the request data for the parts, the Inventec needs to select the brand of product supplier of the parts and the model type of the parts provided by different product supplier members, then the Inventec inputs the serial number and the fault description of the 9 returned parts individually, on the date: Dec. 12, 2000. The website system 100 tells if the returned part is in warranty by the serial number. The series number indicates manufacturing data about the returned product, like producing factory, producing time, etc., which is predetermined by the respective product supplier member. As shown in FIG. 8, after the Inventec finish filling 9 returned parts in the “RMA Request”, the RMA processor 150 generates a “RMA Confirmation” displaying screen automatically to the Inventec. The “RMA Confirmation” displays a RMA No. “DPT00L220”, the content of request and a selected proper repair center “Display Products Technology” (DPT) and associated data in the “RMA Confirmation”. As shown in FIG. 9, a “RMA Summary” information item will be displayed a RMA status summary for the Inventec, the Inventec can choose different statuses of RMA and different date range to obtain the life cycle of the RMA, which is transferred by the data exchanging means 140 and provided by the related repair center. In FIG. 9, according to the chosen condition, the life cycle of the RMA No. “DPT00L220” is shown in the RMA status summary from the date: Nov. 19, 2000 to the date: Dec. 19, 2000.

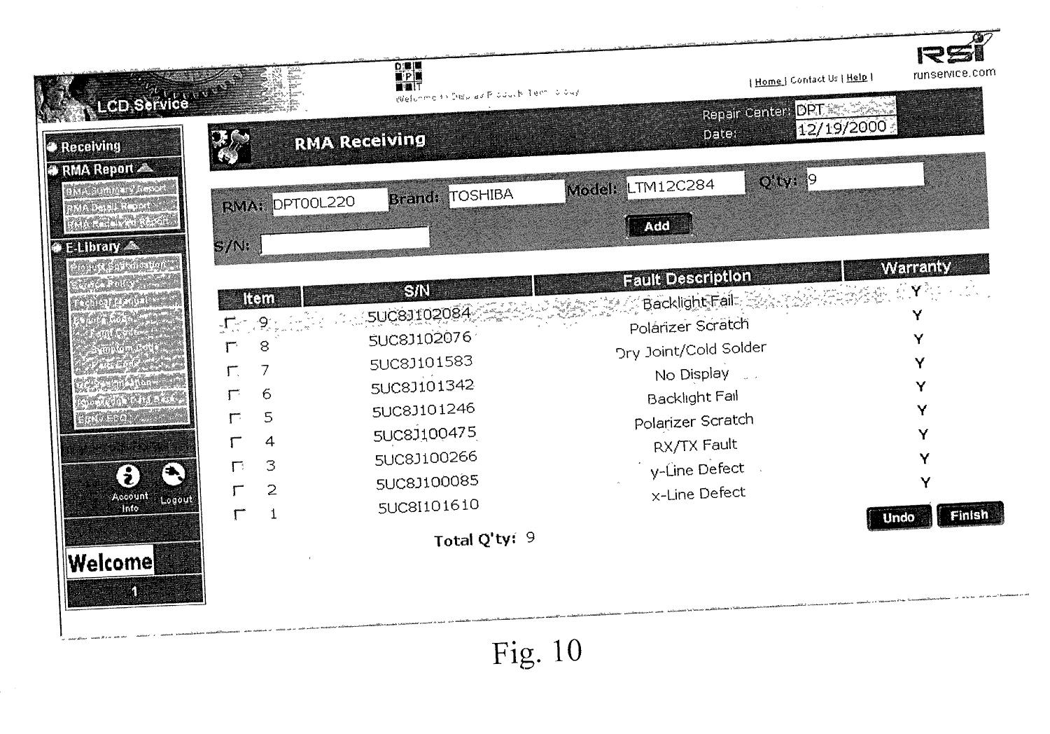

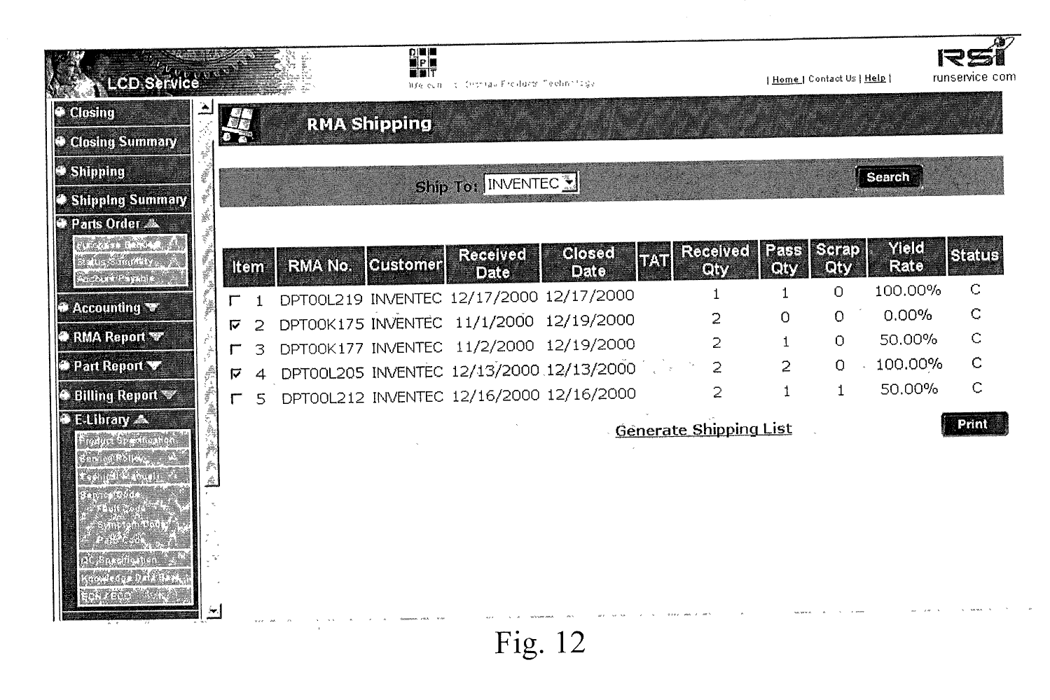

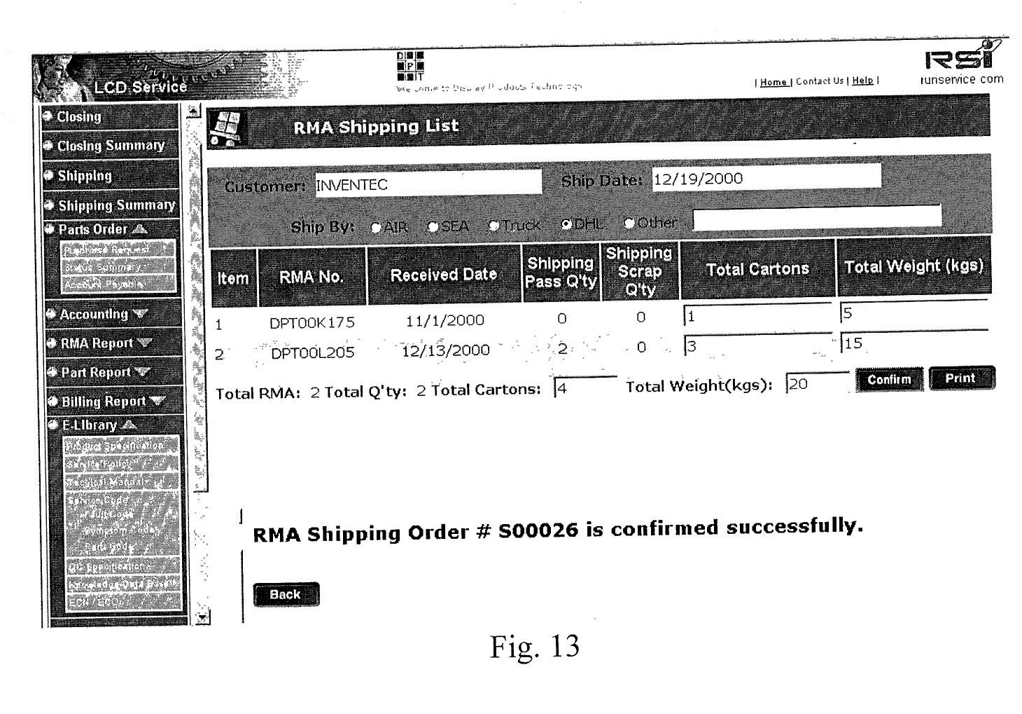

When the RMA processor 150 generates the RMA No. “DPT00L220” for the service requester, the selected repair center “DPT” will also receive the data of RMA No. “DPT00L220”. First, all relative RAM is shown in a “RMA List“ displaying, as shown in FIG. 10. For more detail data, the DPT can enter in a “RMA Receiving” displaying to obtain the data transferred by the data exchanging means 140 and provided by the Inventec. After the DPT finishes repair work for the RMA No. “DPT00L220”, the DPT needs to report a broken symptom and a repair result in a “RMA Closing” displaying for each returned part of the RMA No. “DPT00L220”, as shown in FIG. 12. After closing the RMA, the DPT has to ship the repaired parts back to the Inventec. As shown in FIG. 13, a “RMA Shipping” displaying shows all RMAs an associated data needed to be shipped to the Inventec. For generating a shipping list for the two selected RMA items in FIG. 13, the DPT inputs more detail shipping information for this shipment.

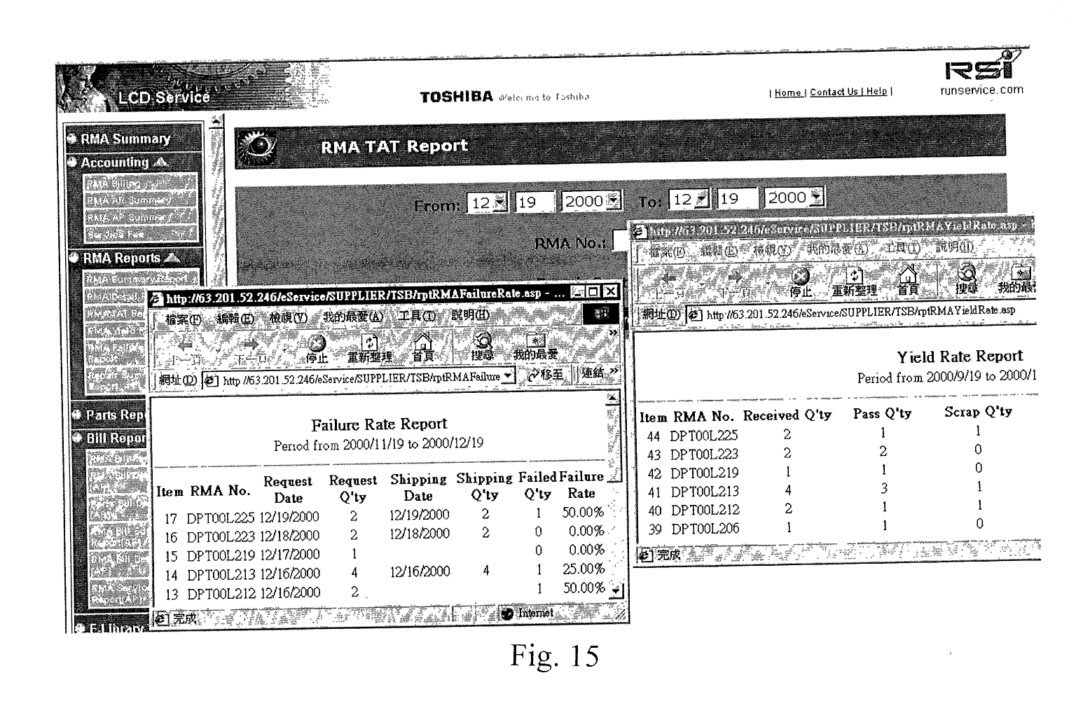

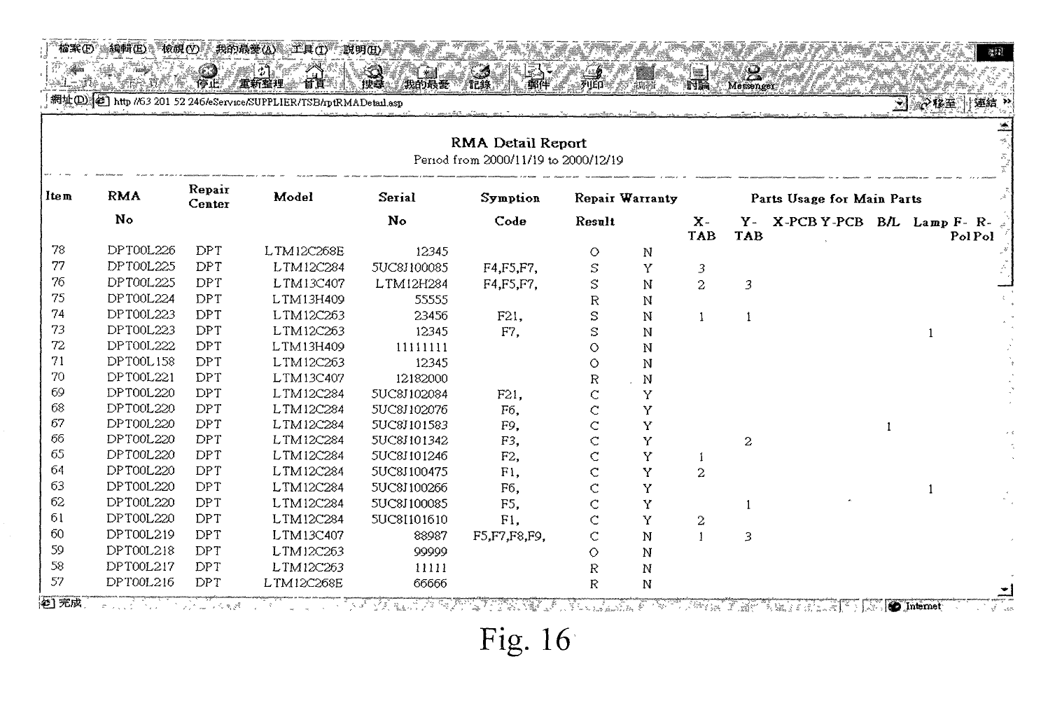

For the product supplier—“TOSHIBA” company, the interface of the website system 100 provides several different RMA reports, such as TAT report, failure rate report, yield rate report, RMA detail report, etc., as shown in FIG. 15 and FIG. 16. So the TOSHIBA can observe the quality of the its parts and study the failure reason to improve.

The present invention provides several premier advantages over other alternatives:

The application of the present invention provides can be customary designed for the repair and return process. No “duct tape” system in picture.

All the return and repair process related information is stored in a centralized location with unified format. It makes the task of information sharing easily achieved.

The present invention becomes the major coordinator of collaboration. No member needs to take the burden as the beacon for process streamlining.

There is only one set of applications running in the present invention. The development and maintenance cost for the software is thus lower. No additional installation cost for the members, either.

The operating cost of the present invention can be evenly shared by the members.

But most importantly, the present invention employs a “pull” mechanism instead of the “push” mechanism imposed by the network. The present invention pulls the information out from its database, aggregate the information if necessary, and present the aggregated information to members in a unified format. Furthermore, the present invention can pull the data from members' information system and then compile and aggregate this information. In short, the present invention now serves as the centralized information aggregator and feeds appropriate information to its members.

The e2R (eReturn&Repair) paradigm is a new thought that advocates using Internet as a platform for the return and repair process. With the rapid growth of today's net economy, e2R is the natural next step for the fast growing B2B e-commerce.

In the meantime, the present invention model solves many issues regarding the information sharing and enterprise collaboration, which are the major problems for today's return and repair process. By adapting the present invention model as the foundation, companies can now start moving toward to e2R (eReturn&Repair) paradigm to streamline the two R processes.

Some company, mostly major OEM, is taking the role as the present invention in order to promote the e2R paradigm while some new start-up company is entering the e2R market as the present invention. Regardless the present invention is initiated by the OEM or third party, the importance of e2R has been well perceived among the industries.

There is no doubt that the e2R is the next major trend in the B2B e-commerce. The only question that remains is which companies will emerge as leaders adopting this new paradigm quickly for competitive advantages, and which will be the followers.

For companies that want to streamline their return and repair process, reduce the waste and get better quality control, e2R can provide these and many other benefits. The rapid maturation of Internet technologies has made e2R much easier to implement and more cost effective than other paradigms such as extranet.

In addition, e2R paradigm can be part of the many-ends-to-many-ends eBusiness integration approach that includes business process automation inside the enterprise, with repairing partners and customers over the Internet. With e2R paradigm, the eBusiness integration can now cover all aspects of the business process.

Although the present invention has been explained in relation to its preferred embodiment, it is to be understood that many other possible modifications and variations can be made without departing from the spirit and scope of the invention as hereinafter claimed.

What is claimed is:

1. A website system for providing on-line data-exchange and a collaborative service for return and repair processes via a network, the website system enabling integration of service information from a service community, the service community including: a service requester party, a repair center party and a product supplier party, the website system comprising:
a website server connected to the network;
a database for storing attribute data provided by each member of the service community and generated by the website system;
an access controlling means for generating a user ID code for each member of the service community according to the attribute information;
a data exchanging means for providing three different interfaces for three parties, respectively, to receive and exchange different data real-time among three parties, each interface having a plurality of information items for the same party;
a return material authorization (RMA) processor for generating an RMA for a proper repair center and a service requester and managing a life cycle of the RMA, when receiving a service request with the associated data of at least one returned product from the service requester;
a repair execution system (RES) connected to the RMA processor, for administering and tracking a repair process of the returned product, according to repair data provided by the repair center;.
a bill evaluating system for evaluating a bill of the repair process of the returned product for involved parties intelligently, according to the repair data and a predetermined bill splitting rule; and
a part procuring system for processing parts procurement for the repair process by gaining repair data from the RES and the repair center, and sending part data to the product supplier and the bill evaluating system;

2. The website system of claim 1, wherein the associated data of the returned product includes: a series number and a failure description inputted by the service requester.

3. The website system of claim 2, wherein the series number indicates manufacturing data about the returned product, like producing factory, producing time, etc.

4. The website system of claim 1, wherein the access controlling means further comprising:
a power limiting means for defining usage limitation of exchanged data for each party.

5. The website system of claim 1, wherein the return material authorization (RMA) processor further comprising:
an intelligent service routing means for determining the proper repair center for each service request according to the location of the repair center provided by the user ID.

6. The website system of claim 1 further comprising:
a repair report sharing means for integrating repair report from each repair center and automatically informing to the other related member via the website system.

7. The website system of claim 1, wherein the life cycle of the RMA includes: status, turn-around time (TAT), the date of different period, yield rate, failure rate, and part usage.

8. The website system of claim 1, wherein the interface presents a plurality of different information items for each party, respectively.

9. The website system of claim 1, wherein the bill includes the repair cost, the parts procurement cost, and the other return and repair related cost.

10. The website system of claim 1, wherein the predetermined splitting rule includes a warranty agreement provided by the product supplier party and repair execution.

11. The website system of claim 10, wherein the repair execution is decided by a plurality of failure symptoms and the failure symptoms is provided by the repair center party.

12. The website system of claim 1, wherein the repair execution system (RES) is further for monitoring any quality issue discovered in the repair process and altering quality control personnel.

13. The website system of claim 1, wherein the part procuring system further comprising:
a part logistic means connected to every inventory database of the repair center party and the product supplier party for ordering lacking part from the related product supplier.

14. The website system of claim 1, wherein every member of the service community can be defined as more than one party.

15. A method for providing on-line data-exchange and a collaborative service for return and repair processes via a network, which enabling integration of service information from a service community, the service community including: a service requester party, a repair center party and a product supplier party, the method comprising:
providing a website system on the network that provides service for connecting three parties of the service community;
requesting every member of the service community to provide associated attribute information and storing the information;
generating a user ID code for each member of the service community according to the attribute information to define a proper party role for every login user;
providing different interfaces for each three parties to input data and to exchange data real-time
defining usage limitation of the exchanged data for each party of the service community;
receiving a service request for a returned product including associated data from a service requester;
generating an RMA of the returned product for a proper repair center and the service requester and managing a life cycle of the RMA;
receiving repair data for a repair process provided from the repair center party and sharing repair data with the other parties;
evaluating a bill of the repair activity process of the returned product and determining related payers intelligently, according to the repair data and a predetermined bill splitting rule; and
processing part procurement for the repair process.

16. The method of claim 15, wherein the associated data of the returned product includes: a series number and a failure description inputted by the service requester.

17. The method of claim 16, wherein the series number shows manufacturing data about the returned product, like producing factory, producing time, etc.

18. The method of claim 15 further comprising a step of:
integrating repair report from each repair center and automatically informing to the related repair center via the website system.

19. The method of claim 15, wherein the life cycle of RMA includes: status, turn-around time (TAT), yield rate, failure rate and part usage.

20. The method of claim 15, wherein the interface presents a plurality of different information items for each party, respectively.

21. The method of claim 15, wherein the bill includes the repair cost, the parts procurement cost, and the other return and repair related cost.

22. The method of claim 15 further comprising a step of:
determining a proper repair center for each service request according to the location of the repair center provided by the user ID.

23. The method of claim 15, wherein the predetermined splitting rule includes a warranty agreement provided by the product supplier party and repair execution.

24. The method of claim 23, wherein the repair execution is decided by a plurality of broken symptoms, and the broken symptoms is provided by the repair center party.

25. The method of claim 15 further comprising a step of:
monitoring any quality issue discovered in the repair process and altering quality control personnel.

26. The method of claim 15 further comprising a step of:
ordering lacking part from the related product supplier by connecting to every inventory database of the repair center party and the product supplier party.

27. The method of claim 15, wherein every member of the service community can be defined as more than one party.
